(19) United States
(12) Patent Application Publication
(10) Pub. No.: US 2019/0009264 A1
(43) Pub. Date: Jan. 10, 2019

(54) Process For Producing A Catalyst

(71) Applicant: CONTINENTAL AUTOMOTIVE GmbH, Hannover (DE)

(72) Inventors: Peter HIRTH, Rösrath (DE); Thomas HÄRIG, Neunkirchen-Seelscheid (DE)

(21) Appl. No.: 16/079,410

(22) PCT Filed: Feb. 22, 2017
(86) PCT No.: PCT/EP2017/054085

§ 371 Date: Aug. 23, 2018

(30) Foreign Application Priority Data
Feb. 25, 2016 (DE) 10 2016 203 017.5

(51) Int. Cl. B01J 37/08; C21D 9/00; C21D 6/00; B01J 35/00; B01J 23/86; B01J 21/02; B01J 37/02

(52) U.S. Cl. CPC B01J 37/08; C21D 9/0068; C21D 6/002; B01J 35/0033; F01N 3/2026; B01J 21/02; B01J 37/0215; C21D 2211/005; B01J 23/862

(57) ABSTRACT

A process for producing a catalyst having a heating element that is formed from an electrically conductive metal alloy. In the production process, the catalyst undergoes at least a first heat treatment, during which the catalyst is at least partly heated in defined fashion and cooled in a defined fashion. The steps include heating at least a subregion of the catalyst to a predeterminable temperature of at least 550 degrees celsius, holding the temperature at a constant temperature level for at least two minutes, and cooling the at least one subregion of the catalyst at a temperature transient of at least 500 Kelvin per minute.

### CROSS REFERENCE TO RELATED APPLICATIONS

This is a U.S. national stage of application No. PCT/EP2017/054085, filed on Feb. 22, 2017. Priority is claimed on German Application No. DE102016203017.5, filed Feb. 25, 2016, the content of which is incorporated here by reference.

### BACKGROUND OF THE INVENTION

### 1. Filed of the Invention

The invention relates to a process for producing a catalyst comprising at least one heating element, wherein the heating element is formed from an electrically conductive metal alloy. During the production process the catalyst undergoes at least a first heat treatment, wherein the catalyst is at least partly heated a in defined fashion and cooled in a defined fashion. The invention further relates to a catalyst completely or partly produced by the process according to the invention.

### 2. Description of the Prior Art

Electric heating of catalysts in an exhaust gas system is achieved inter alia using electrically conductive materials connected to a voltage supply. The ohmic resistance allows a heating of the electrically conductive material to be generated. Preferably the heating conductors are metallic alloys.

Since the electrical energy available in a motor vehicle is limited and having regard to the increasing requirements in terms of energy efficiency of motor vehicles it is necessary to achieve the most efficient possible heating. To this end the resistance value of the heating alloys used must be able to be adjusted as precisely as possible in order to be able to achieve a precisely defined and predetermined heating with the available energy.

The heating of current-carrying conductors on the basis of ohmic resistance is in principle very well known and realized in a multiplicity of applications.

A disadvantage of hitherto known processes and apparatuses in the prior art is in particular that the resistance value of the materials used is not adjustable with sufficient precision. This applies in particular to metal alloys used for the manufacture of catalysts since in the production process the metal alloys are at least once subjected to a heat treatment as a result of which the metal microstructure and thus also the resistance value of the alloy may change. This change in the metal microstructure depends on the chosen boundary conditions, for example the temperature profile over time during the respective heat treatment.

Due to the broad distribution of the resistance values that can occur in the course of heat treatments a precise prediction of the established resistance value of the alloy is possible only in very few cases.

### SUMMARY OF THE INVENTION

A problem addressed by one aspect of the present invention is providing a process that allows for subjecting a metal alloy at least to a necessary heat treatment while at the same allowing a very precise prediction of the change in the resistance value of the metal alloy. A further problem addressed by the invention is that of providing a catalyst comprising a metal alloy treated by the process according to the invention.

One exemplary embodiment of the invention relates to a process for producing a catalyst comprising at least one heating element, wherein the heating element is formed from an electrically conductive metal alloy, wherein in the production process the catalyst undergoes at least a first heat treatment, wherein the catalyst is at least partly heated in defined fashion and cooled in defined fashion, wherein the following steps are carried out:
heating at least a subregion of the catalyst to a predeterminable temperature of at least 550 degrees celsius,
holding the temperature at a constant temperature level for at least two minutes,
cooling the at least one subregion of the catalyst at a temperature transient of at least 500 Kelvin per minute [K/min].

The process is particularly advantageous since the strong heating in conjunction with a holding time at the high temperature level and the cooling at a high temperature transient can achieve an advantageous change in the metal microstructure. In particular a retroformation of disadvantageous metal microstructures can be achieved.

A temperature transient is to be understood as meaning a change in temperature over time (dT/dt). In the present exemplary embodiments the changeability of the temperature is in each case reported as a change in Kelvin per minute [K/min] and relates predominantly to a defined cooling from a predetermined temperature level.

The process is particularly advantageously directed to effecting dissolution or retroformation of metal microstructures having a strong effect on the original resistance value of the chosen metal alloy in order to minimize the change in the resistance value or to keep the resistance within foreseeable limits.

It is particularly advantageous when a heating to at least 700 degrees celsius is performed. A heating to at least 700 degrees celsius is advantageous since at this temperature level or higher the transformation of the metal microstructure may be effected in a particularly simple and comprehensive fashion. The temperature level is in particular advantageous since it is above the operating temperature of other heat treatments regularly used in the production of catalysts. For example calcination in the context of a surface coating.

In an advantageous embodiment the entire catalyst may be subjected to the heat treatment. It is alternatively also possible to carry out only a treatment of a subregion of a catalyst. In particular, the metal foils arranged in the catalyst or other structures arranged in the catalyst may be subjected to a heat treatment in isolation from the other components of the catalyst. This is advantageous for example to avoid destruction of joints, for example of solder joints, by the heat treatment.

It is also advantageous when the hold time at the temperature level to which the catalyst has been heated is at least four hours. A long hold time of approximately 4 hours or more is particularly advantageous to achieve the most extensive and complete transformation of the metal microstructure. The greater the proportion of the metal microstructure that can be transformed or retroformed the more precisely the resistance value ultimately established in the metal alloy may be predicted. The reason for this is that the metal microstructure is subjected to transformation or retroformation, which results in a negative change in the resistance value.

A precise knowledge of the resistance value established at the end of the production is necessary to reliably achieve the required heating with the available current. On account of the increasingly energy-efficient configuration of motor vehicles individual electrical consumers are provided with very precisely defined and tightly limited currents with which the heating predetermined by the manufacturer must be realized in a predetermined time.

A preferred exemplary embodiment is characterized in that the temperature transient during the cooling is at least 2400 Kelvin per minute [K/min]. The strong and rapid cooling at a particularly high temperature transient has the result that the microstructure retroformed by the heating and the holding at the elevated temperature level is not reformed. When the lower temperature ranges, in particular the temperature ranges directly below the maximum temperature (up to about 450 degrees celsius), are passed through too slowly a reforming of the disadvantageous metal microstructure may occur.

It is also preferable when the at least first heat treatment is downstream of at least a second heat treatment, wherein the first heat treatment at least partly reverses a change in the metal microstructure of the metal alloy resulting from the upstream second heat treatment.

A second heat treatment that precedes the first heat treatment may for example be a consequence of a coating procedure or of a joining process. In this second heat treatment a disadvantageous transformation of the metal microstructure may form, which can result in a negative effect on the resistance value of the metal alloy.

It is furthermore advantageous when the upstream second heat treatment converts the metal alloy into the so-called alpha-prime phase, wherein the downstream first heat treatment achieves a dissolution of the alpha-prime phase in the metal alloy.

The alpha-prime phase is known from the literature in the context of an iron-carbon diagram. This phase is characterized by the formation of a specific metal microstructure. The alpha-prime phase results in embrittlement of the ferritic phase of the metal alloy. The alpha-prime phase preferably forms below about 500 degrees celsius. This alpha-prime phase can be redissolved or retroformed by renewed heat treatment.

It is further advantageous when the second heat treatment is a joining process or a coating process. Provided a joining process, for example soldering, is concerned it must be ensured that the renewed heat treatment does not result in destruction of the joints on account of the high upper temperature level or on account of the rapid cooling after the holding of the upper temperature level.

It is also advantageous when a coating of the inner and/or outer surfaces of the catalyst with a surface-area-increasing coating is carried out upstream of the second heat treatment. This is advantageous for promoting the conversion of the exhaust gas inside the catalyst by increasing the reactive surface area.

One exemplary embodiment of the invention relates to a catalyst comprising at least one electrically heatable element, wherein the electrically heatable element is formed by an electrically conductive metal alloy and is heatable by utilization of ohmic resistance, wherein the catalyst is at least partly producible by a process according to any of the preceding claims.

Such a catalyst is advantageous since in particular the heating element for heating the catalyst has a resistance value that is predictable on the basis of the original material properties of the chosen metal alloy. Said catalyst is advantageously unchanged or changed only to a very small extent compared to the original metal alloy. The heating element may preferably also be subjected to treatment as per the process according to the invention in isolation from the housing of the catalyst or the other elements, for example the honeycomb structures, in order to be able to subject the heating element to a heat treatment without regard for the other elements of the catalyst.

Advantageous developments of the present invention are described in the subsidiary claims and in the following description of the figures.

### BRIEF DESCRIPTION OF THE DRAWINGS

The invention will be discussed in detail below using exemplary embodiments and with reference to the drawings. In the drawings:

FIG. 1 is a diagram showing the change in the resistance value for a metal alloy (material 1.4767), wherein a heating to about 600 degrees celsius and a hold time of about four hours is followed by a cooling at a temperature transient of −1 K/min;

FIG. 2 is a diagram showing the change in the resistance value for a metal alloy (material 1.4767), wherein a heating to 700 degrees celsius has been carried out and after a hold time of four hours a cooling at a temperature transient of 2400 K/min has been performed; and

FIG. 3 shows a block diagram for elucidating the process according to the invention.

### DETAILED DESCRIPTION OF THE INVENTION

FIG. 1 shows a diagram which along the x-axis depicts the temperature 1, in particular the hold temperature, of the metal alloy. In the case of FIG. 1 the metal alloy is heated to about 600 degrees celsius during the hold time provided for in the process. For cooling, the metal alloy, formed from material 1.4767 in the present case, is cooled at a temperature transient of 1 Kelvin per minute [K/min]. This may preferably be effected by simple cooling in air at room temperature.

Curve 3 shows the respective percentage change in the resistance coefficient of the metal alloy at different starting temperatures provided that from this starting level a cooling of approximately one Kelvin per minute is effected. The change in the resistance coefficient is plotted as a percentage change from the starting state along the y-axis 4.

It can be read-off along the arrows 2 that in the case of a starting temperature of 600 degrees celsius and the above-described cooling a reduction in the resistance value of about 5.5% results.

This correlation relates in particular to material 1.4767 which is chosen by way of example and is an aluminum-chromium alloy. Similar materials result in divergent but qualitatively similar correlations and the chosen example must therefore be regarded as representative.

Depending on other boundary conditions, for example the expected stress in later operation or the corrosive properties of the fluid flowing through the catalyst, it may be necessary to specify a particular metal alloy. If an excessively low end resistance then is achieved on account of the negative change in the resistance value during the heat treatment, the necessary heating power cannot be achieved with the available current.

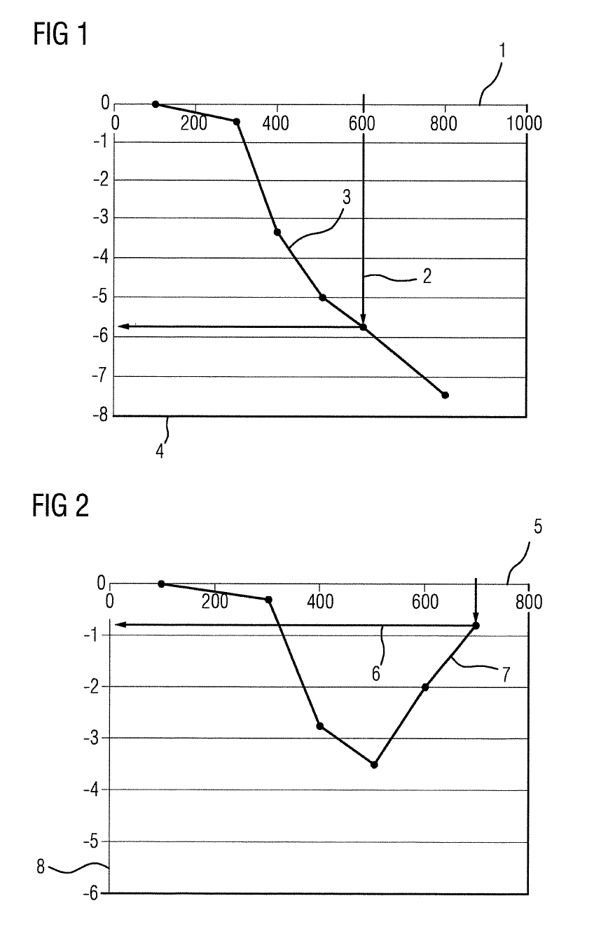

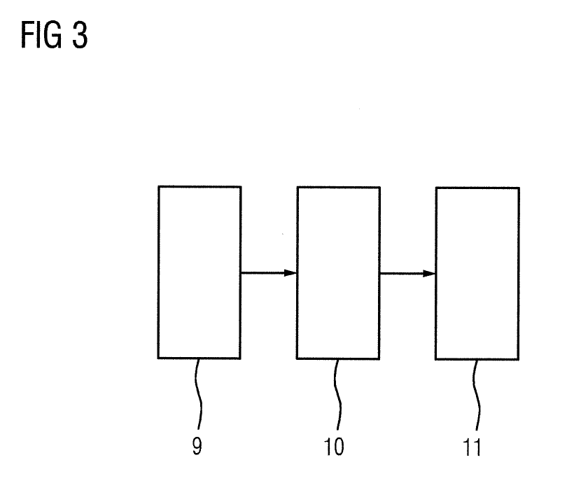

FIG. 2 shows a diagram similar to FIG. 1. The hold temperature of the metal alloy is again plotted along the x-axis 5. In FIG. 2 the hold temperature in the chosen example is about 700 degrees celsius, wherein a cooling at a transient of about 2400 Kelvin per minute is performed. The diagram of FIG. 2 corresponds to the change in resistance during the process according to the invention while the diagram of FIG. 1 reflects by way of example the change in resistance during a heat treatment in an upstream process step.

The percentage change in the resistance value is plotted along the y-axis 8. It is possible to read-off along the curve 7 the percentage changes in the resistance value during the above-described cooling of 2400 Kelvin per minute for the respective starting temperatures on the x-axis.

A starting temperature of 700 degrees celsius thus results, in accordance with the arrows 6, in a percentage change in the resistance value of about 1%.

Since the change in the resistance value is reversible, a strong reduction in the resistance value, as shown in FIG. 1, may for example be compensated or reversed again by a process as proposed in accordance with the invention and employed in FIG. 2. This is advantageous since in this way the necessary process steps for achieving other material properties can be performed unchanged and any negative effect on the resistance value can be corrected retrospectively.

FIG. 3 is a block diagram of the process according to the invention. In block 9 the metal alloy is heated to a target temperature. In block 10 this target temperature is held for a predetermined time. In block 11 the metal alloy is finally cooled at a predefined temperature transient.

The diagrams in FIGS. 1 and 2 by way of example relate to a certain material (1.4767) and in particular do not have any limiting character. Related metal alloys may likewise be utilized for the application of the process according to the invention. The choice of the temperature transients and the hold temperature is likewise exemplary and may be varied within the limits according to the invention.

The figures shown serve to elucidate the inventive concept and do not have any limiting character.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A process for producing a catalyst comprising at least one heating element that is formed from an electrically conductive metal alloy having at least a first heat treatment during which the catalyst is at least partly heated in a defined fashion and cooled in a defined fashion, comprising:
heating at least a subregion of the catalyst to a predeterminable temperature of at least 550 degrees Celsius;
holding the temperature at a constant temperature level for a hold time of at least two minutes; and
cooling the at least a subregion of the catalyst at a temperature transient of at least 500 Kelvin per minute [K/min].

11. The process as claimed in claim 10, wherein a heating to at least 700 degrees Celsius is performed.

12. The process as claimed in claim 10, wherein the hold time at the temperature level to which the catalyst has been heated is at least four hours.

13. The process as claimed in claim 10, wherein the temperature transient during the cooling is at least 2400 Kelvin per minute [K/min].

14. The process as claimed in claim 10, wherein the at least the first heat treatment is downstream of at least a second heat treatment, wherein the first heat treatment at least partly reverses a change in a metal microstructure of the metal alloy resulting from the upstream second heat treatment.

15. The process as claimed in claim 14, wherein the upstream second heat treatment converts the metal alloy into an alpha-prime phase, wherein the downstream first heat treatment achieves a dissolution of the alpha-prime phase in the metal alloy.

16. The process as claimed in claim 14, wherein the second heat treatment is a joining process or a coating process.

17. The process as claimed in claim 14, wherein a coating of inner and/or outer surfaces of the catalyst with a surface-area-increasing coating is carried out upstream of the second heat treatment.

18. A catalyst comprising at least one electrically heatable element, wherein the electrically heatable element is formed by an electrically conductive metal alloy and is heatable by utilization of ohmic resistance, wherein the catalyst is at least partly producible by a process comprising:
heating at least a subregion of the catalyst to a predeterminable temperature of at least 550 degrees Celsius;
holding the temperature at a constant temperature level for at least two minutes; and
cooling the at least one subregion of the catalyst at a temperature transient of at least 500 Kelvin per minute [K/min].
